(19) United States
(12) Patent Application Publication
(10) Pub. No.: US 2010/0262463 A1
(43) Pub. Date: Oct. 14, 2010

(54) Systems, Methods, and Media for Management of a Survey Response Associated with a Score

(76) Inventor: Jason Tryfon, Milton (CA)

Correspondence Address: CARR & FERRELL LLP, 2200 GENG ROAD, PALO ALTO, CA, 94303, US

(21) Appl. No.: 12/423,767

(22) Filed: Apr. 14, 2009

(51) Int. Cl. G06Q 10/00; G06Q 50/00

(52) U.S. Cl. 705/10; 705/7

(57) ABSTRACT

A computer-implemented method for management of a survey response associated with a score is disclosed. Exemplary systems and methods include a processor, a computer readable storage medium having instructions for execution by the processor, and the processor executing the instructions on the computer readable storage medium to transmit a survey response associated with a score for display on a network device. If the score of the survey response is below a threshold, the processor transmits an issue report for display on the network device. The processor also transmits a calculated value for display on the network device, the calculated value based at least in part on the score associated with the survey response. In a further exemplary system and method, the processor transmits for display on the network device a quantity representing a number of survey responses that may have their associated score deducted from the calculated value. According to yet another exemplary system and method, the processor receives from the network device an assignment of an issue report to a party responsible for resolution of the issue report.

### FIELD OF INVENTION

The present application is related to U.S. patent application Ser. No. ______, titled “Systems, Methods, and Media for Survey Management,” filed concurrently herewith on Apr. 14, 2009.

The present invention relates generally to management of survey responses, and more particularly, computerized methods for generating, managing and displaying a survey response associated with a score.

### BRIEF SUMMARY OF THE INVENTION

Provided herein are exemplary systems, methods and media for management of a survey response associated with a score. Exemplary systems and methods include a processor, a computer readable storage medium having instructions for execution by the processor, and the processor executing the instructions on the computer readable storage medium to transmit the survey response associated with the score for display on a network device. If the score of the survey response is below a threshold, the processor transmits an issue report for display on the network device. The processor also transmits a calculated value for display on the network device, the calculated value based at least in part on the score associated with the survey response.

In a further exemplary system and method, the processor transmits for display on the network device a quantity representing a number of survey responses that may have their associated score deducted from the calculated value. The quantity may be based at least in part on a total number of survey responses received during a pre-specified time period. The processor may also transmit when one or more of the associated scores must be deducted from the calculated value.

In another exemplary system and method, the processor receives from the network device a request to appeal inclusion of a score associated with the survey response in the calculated value. The processor may also receive from the network device a reason in support of the request to appeal inclusion of the score. The processor may also transmit for display on the network device a granting of the request to appeal, the granting resulting in deduction of the associated score from the calculated value. The processor may also remove the survey response associated with the deducted score from being accessed by the network device.

According to yet another exemplary system and method, the processor receives from the network device an assignment of an issue report to a party responsible for resolution of the issue report. The processor may track a time period starting with the transmitting of the issue report and ending with closure of the issue report. The processor may receive from the network device an indication that the issue has been resolved and/or that the issue report has been closed. The processor may transmit a request for confirmation that the issue report has been satisfactorily closed.

Also provided herein are exemplary graphical user interfaces for management of a survey response associated with a score. Such exemplary graphical user interfaces may include a survey response display, the survey response display configured to display a survey response associated with a score, an issue report display, the issue report display configured to display an issue report if the score of the survey response is below a threshold, and a calculated value display, the calculated value display configured to display a calculated value based at least in part on the score associated with the survey response. Further exemplary graphical user interfaces may include a status display, the status display configured to display a status of the survey response, and/or a comment display, the comment display configured to display a comment about the survey response.

### BRIEF DESCRIPTION OF THE DRAWINGS

FIG. 1 is an exemplary networking environment in accordance with embodiments of the present invention.

FIG. 2 is a flowchart of an exemplary computer-implemented method for management of a survey response associated with a score.

FIG. 3 illustrates an exemplary Graphical User Interface (GUI) for management of a survey response associated with a score in accordance with embodiments of the invention.

FIG. 4 illustrates an exemplary view of the GUI of FIG. 3.

FIG. 5A-5F illustrates an exemplary view of the GUI of FIG. 3.

FIG. 6A-6D illustrates an exemplary view of the GUI of FIG. 3.

### DETAILED DESCRIPTION

Embodiments of the present invention provide systems, methods, and media for managing a survey response associated with a score. A survey response associated with a score may be a product of a survey question, a survey response, and a score based on the survey response.

The systems, methods, and media described herein may make use of computerized surveys that are targeted to a customer based on purchase data. The targeted surveys may include survey questions, the answers to which may provide the seller with the customer service experience provided by the seller's employees, the reason for the customer's visit to the seller, and the like. An exemplary seller who may make use of targeted surveys may be a manufacturer or a dealership of new or pre-owned conveyances or motor vehicles, such as automobiles, motorcycles, resort vehicles, and the like, as well as services associated with the maintenance of such conveyances. In some embodiments, the targeted survey may be made available online via the Web or another network to a customer's digital device, such as a desktop computer or a mobile device. The customer may provide a survey response to the targeted survey. The survey response may include a return of the survey with no survey questions answered, a return of the survey with a portion of the survey questions answered, and a return of the survey with all survey questions answered. In some embodiments, the survey response may include any comments provided by the customer. The customer may provide the survey response to the seller via the Web or another online network.

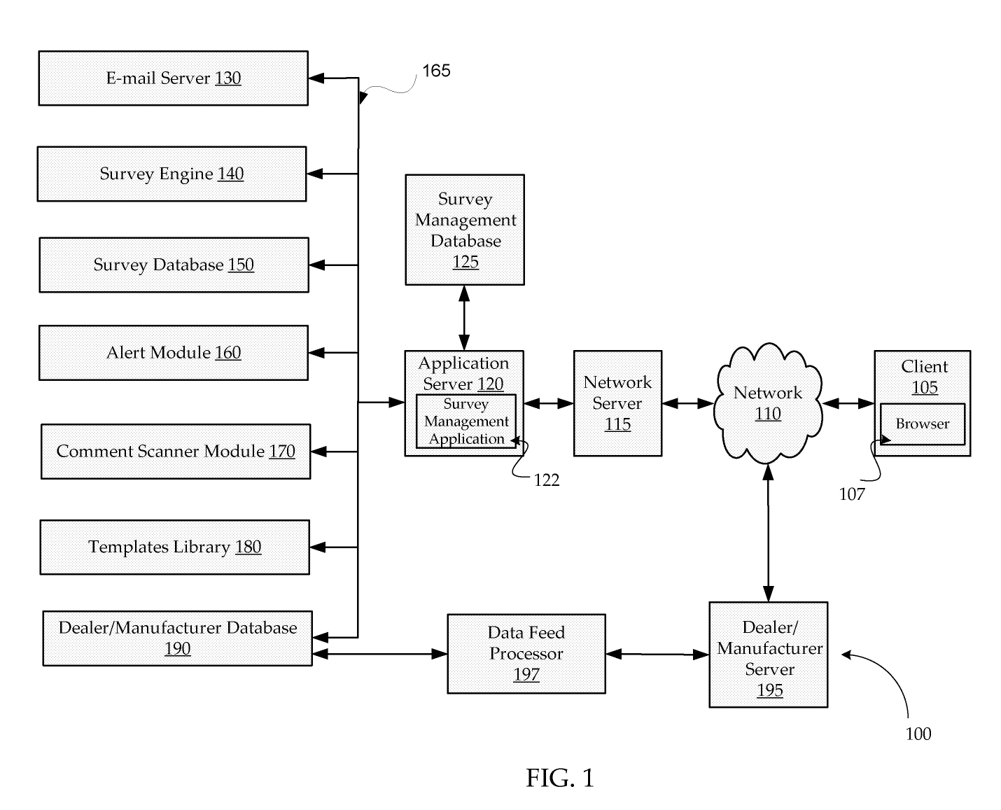

FIG. 1 is an exemplary networking environment 100 in accordance with embodiments of the present invention. The networking environment includes client 105 having browser 107, Network 110, Network Server 115, Application Server 120 hosting Survey Management Application 122, Survey Management Database 125, E-mail Server 130, Survey Engine 140, Survey Database 150, Alert Module 160, Comment Module 170, Templates Library 180, Dealer/Manufacturer Database 190, Dealer/Manufacturer Server 195, and Data Feed Processor 197. Network 110 may be any type of network, including but not limited to the Internet, LAN, WAN, a telephone network, and any other communication network that allows access to data, as well as any combination of these. Client 105 may be any digital device, including, but not limited to a desktop computer, laptop computer, mobile telephone device, and PDA. In some embodiments, Network 110 is coupled to Client 105, Network Server 115, Application Server 120, E-mail Server 130 and Dealer/Manufacturer Server 195. One skilled in the art can appreciate that the networking environment 100 as shown in FIG. 1 is exemplary only and that it is not limited to what is shown. For all figures mentioned herein, like numbered elements refer to like elements throughout.

Application Server 120 and Dealer/Manufacturer Server 195 are coupled to Survey Management Database 125 and Dealer/Manufacturer Database 190, respectively. It will be apparent to one skilled in the art that the embodiments of this invention are not limited to any particular type of server and/or database. In some embodiments, the servers mentioned herein are configured to control and route information via the Network 110 or any other networks (not shown in FIG. 1). The servers herein may access, retrieve, store and otherwise process data stored on any of the databases mentioned herein. The databases mentioned herein are configured to store survey data, which includes, but is not limited to survey question, a survey response, a score based on the survey response, a name, a keyword, purchase data, and/or invoice data, as discussed above. The databases may also store historical action logs associated with server activity. Further, the databases mentioned herein may store information about messages, such as e-mail messages associated with a customer, in particular about whether such e-mail messages were sent, date and time information about when the e-mail messages were sent (e.g. time stamp information), contents of the e-mail message, and the target survey.

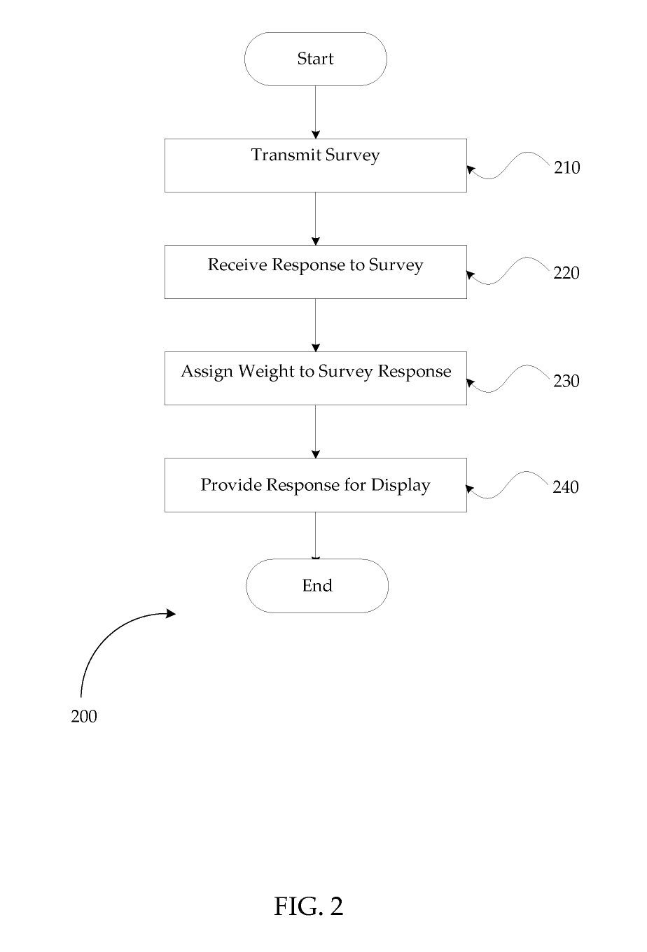

FIG. 2 illustrates an exemplary computer-implemented method 200 for management of a survey response associated with a score.

At step 210, a targeted survey is provided to a customer. In some embodiments, the targeted survey is provided to Application Server 120, which then transmits the targeted survey via Network 110 (via Network Server 115 as shown in FIG. 1) to Browser 107 on Client 105. Alternatively, Application Server 120 may generate a web link and associate the targeted survey with the web link. The web link may be transmitted to E-mail Server 130 to be included in an e-mail message to the customer. One skilled in the art may recognize that although FIG. 1 shows an E-mail Server 130, any type of electronic communication (such as mobile communication) and corresponding network infrastructure is included in the scope of the embodiments described herein.

In step 220, a survey response is received from Client 105 via the web link. As discussed earlier, Client 105 may be any digital device configured to receive a user input corresponding to a survey response. The survey response may include, for example, a text string, a picture, a negative response, a positive response, a character, a numeral, and any combination of these.

In step 230, a weight may be assigned to a survey response. An assigned weight may be quantitative in that statistics may be computed based on numerical values associated with a plurality of survey responses in which the same survey question was asked. For instance, if a survey question from the targeted survey asked a customer to rate her satisfaction with dealership customer service on a scale of 1 to 10, the customer's survey response may indicate a number between 1 and 10. As such, this customer's survey response could then be compared to other targeted surveys in which this survey question was asked.

Survey questions in targeted surveys may be assigned weights, indicating that a particular survey response to a survey question is of higher importance than others. For instance, with respect to mandatory questions which may be asked in every targeted survey, a survey question regarding product knowledge of dealership staff may be of higher importance than a survey question regarding whether the customer was offered a test drive, and therefore, may be weighted more heavily. A weight for a particular survey response to a survey question may be predefined. For instance, the weight of the survey response may be computed based on a weight of the survey question when the targeted survey is generated. Various metrics and/or operations may be performed on the survey response received in 220, and these will be described more fully herein.

In step 240, the weighted survey response may be transmitted for display on a display associated with a digital device. In some embodiments, the weighted survey response may be provided for display on Dealer/Manufacturer Server 195 or on a digital device coupled to Dealer/Manufacturer Server 195 (not shown in FIG. 1). Alternatively, the response may be provided for display on a display associated with Application Server 120, Client 105, and/or E-mail Server 130. The weighted survey response may be provided for display on a plurality of digital devices simultaneously in real time. In other words, the weighted survey response may be provided for display at a dealership and at a manufacturer in real time.

According to various exemplary systems and methods, administrators may set predefined thresholds or criteria for each question in the targeted survey. If a score has been computed for the survey response, the score may be compared to the predefined threshold. If the survey response exceeds the predefined threshold, the survey response may be provided for display as described in the context of step 240. If the survey response does not exceed the predefined threshold, (i.e. the survey response is below the threshold) the survey response may be flagged, and/or a visual indicator may be assigned to the survey response. The survey response may be categorized as, for example, an “Issue.” Responsibility for addressing the “Issue” resulting from the survey response may be assigned to a survey manager. A survey manager may be a particular dealership personnel dedicated to processing and handling issues, or a particular sales advisor or business manager. The survey response (with associated visual indicator) may be provided for display as is described in the context of step 240.

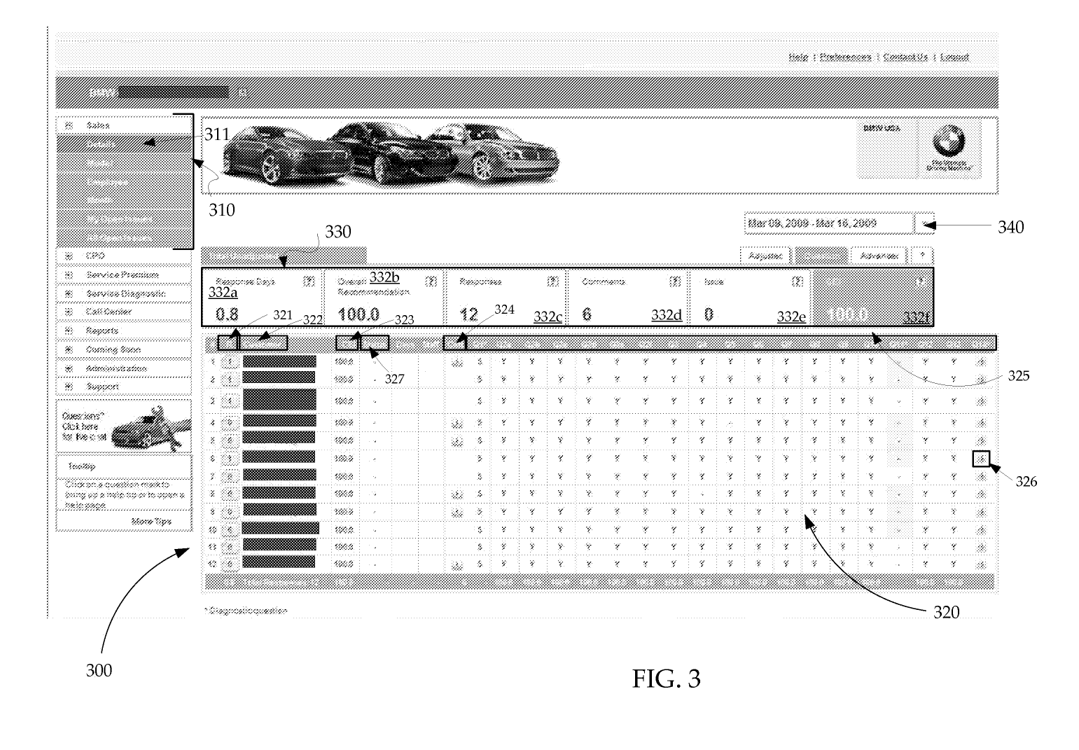

FIGS. 3-6 provide exemplary graphical user interfaces for managing a survey response associated with a score. Although the following figures depict an automobile dealership and survey concerns relating thereto, one skilled in the art will appreciate, upon review of this disclosure, that the systems, methods, and media disclosed herein may be applicable to a plurality of verticals aside from the automotive vertical.

FIG. 3 illustrates an exemplary Graphical User Interface (GUI) 300 in accordance with embodiments of the invention discussed herein. GUI 300 may provide survey data for display as discussed in the context of FIGS. 1 and 2. For example, GUI 300 may be a graphical user interface associated with Survey Management Application 122 and provided via Network 110 to, for example, Dealer/Manufacturer Server 195 or to, for example, a client associated with Dealer/Manufacturer Server 195 (not shown in FIG. 1). GUI 300 may be provided for display on a digital and/or display device associated with Dealer/Manufacturer Server 195 via a browser (not shown in FIG. 1). A user may log into Survey Management Application 122 and navigate GUI 300 via user input to a digital device. Exemplary user inputs may include a mouse click, a mouse double click, a roll-over of a mouse pointer, a key press, a selection of an icon, a selection of an area of a screen using a click and drag, and the like. Components relating to survey management may be displayed on GUI 300. FIG. 3 illustrates Navigation Bar 310, Survey Response Display 320 with Survey Questions 325, Survey Metrics Display 330 with survey metrics indicators 332 displayed thereon, and Date Range Display 340.

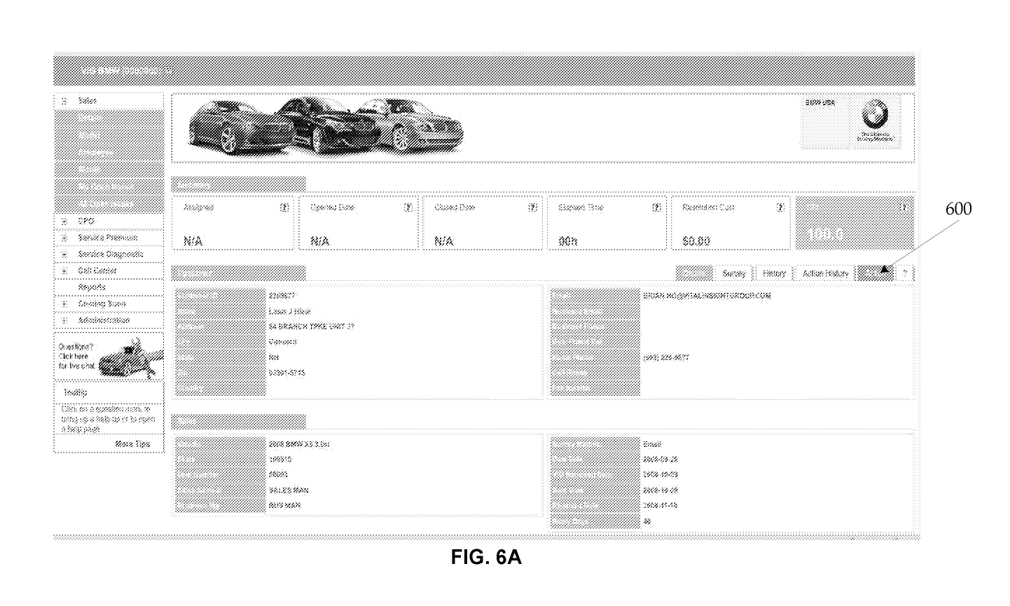

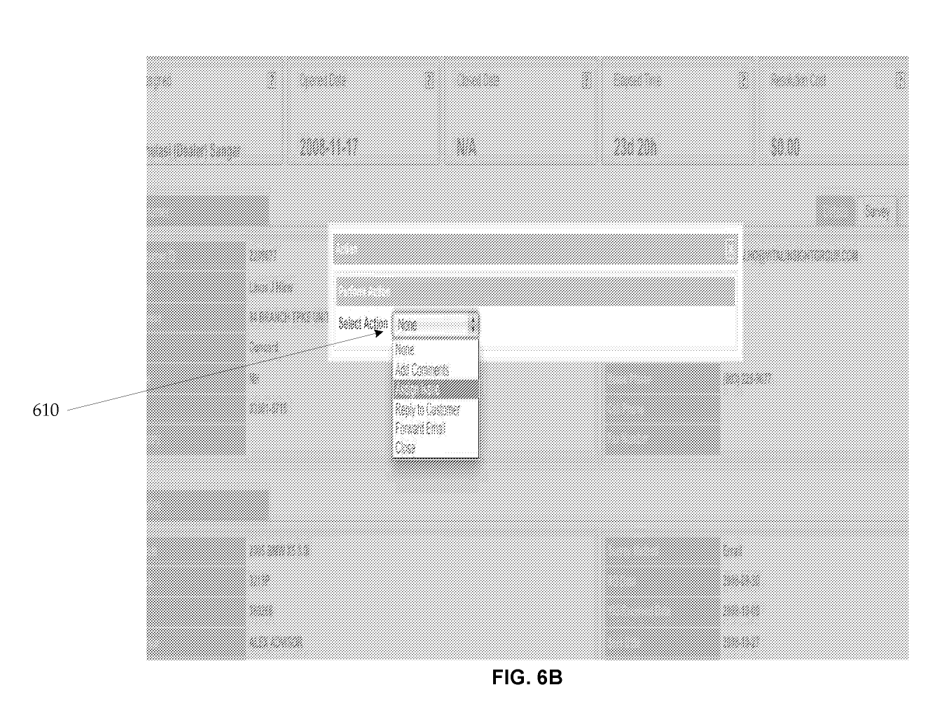

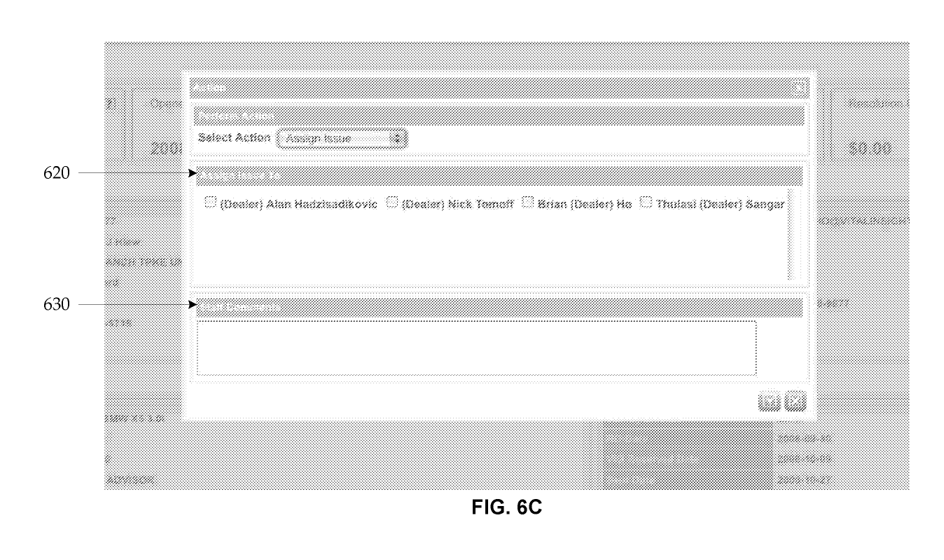

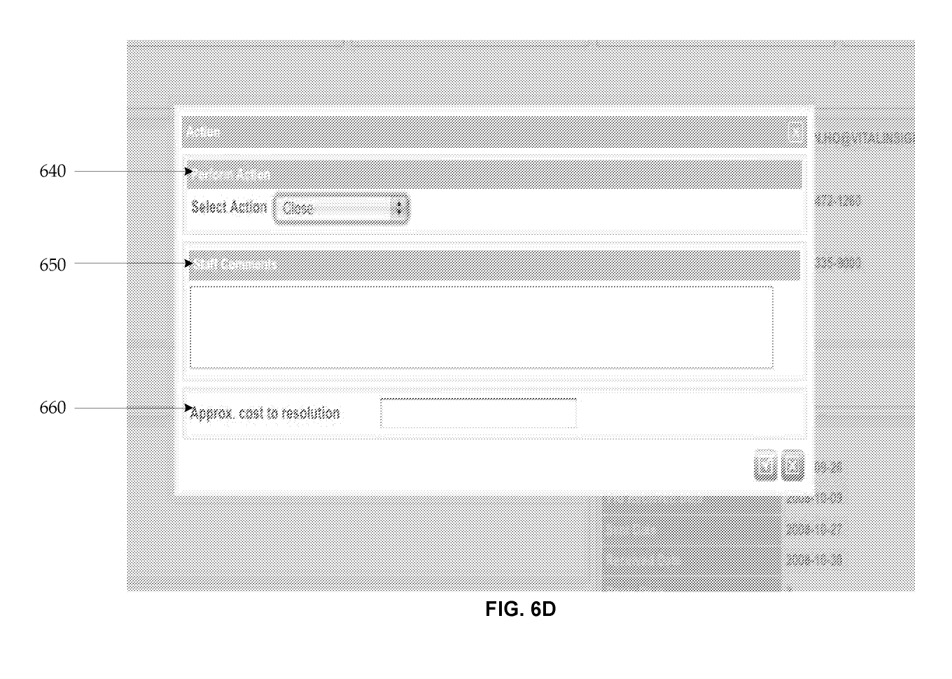

When a user logs into Survey Management Application 122, a user may navigate Tabs 311 of Navigation Bar 310 in order to view survey data. Navigation Bar 310 as shown in FIG. 3 may have any number of tabs 311 which may correspond to any number of views of GUI 300. For example, in FIG. 3 GUI 300 displays a Details View 301 associated with Survey Response Display 320. In some embodiments, Details View 301 may display a number of response days 321, a customer name 322 (customer names not shown in FIG. 3 for privacy), a Customer Experience Index (CEI) 323, a comment 324, and survey questions 325. An activated tab may indicate activation of a view via a visual indicator on the tab 311. For example the Details tab of Navigation Bar 310 is grayed out, indicating that Details View 301 is provided for display by Survey Management Application 122. Additionally, as shown within Navigation Bar 310, issues may be categorized in such ways as “all open issues” and “my open issues.” For example, a user may employ these features to quickly identify all open issue reports and to identify those open issue reports assigned to the user for resolution (as described herein—e.g., in connection with FIG. 6).

In some embodiments, Survey Response Display 320 may be organized as a grid as shown in FIG. 3. A targeted survey as discussed in the context of FIG. 2 may be represented as a row in Survey Response Display 320. The columns of Survey Response Display 320 may represent a number of response days 321, a customer name 322, a CEI 323, a comment 324, and survey questions 325 as shown in FIG. 3. As such, the cells of Survey Response Display 320 may reflect a survey response to a survey question. Survey responses may be displayed, for examples as a character (as shown in FIG. 3), a numeral, a color, an icon, and any combination of these. One skilled in the art will recognize that any number of rows and/or columns may represent any number of variables in Survey Response Display 320.

In some embodiments, weights may be applied to survey responses as discussed in the context of FIG. 2. Survey responses may be displayed in Survey Response Display 320 in association with a weight display (not shown in FIG. 3). A survey tracking display may be displayed in Survey Response Display 320 as shown in Status 327. Status 327 may be configured to display a status of a targeted survey, for example, an indicator associated with whether a survey has been resent to a customer, as discussed in the context of FIG. 1.

Survey Metrics Display 330 may provide survey metrics indicators 332 associated with the survey responses shown in Survey Response Display 320. Survey Metrics Display 330 may, for example, display Response Days 332a, Overall Recommendation 332b, Responses 332c, Comments 332d, Issue 332e, and CEI 332e. Response Days 332a may indicate the average number of days customers took to provide a survey response. Responses 332c may indicate a number of received survey responses. Comments 332d may indicate a number of received comments associated with the survey responses. Issue 332e may indicate a number of issues associated with the survey responses. CEI 332f may indicate a Customer Experience Index score associated with the survey responses. In some embodiments, CEI 332f may represent a weighted average of the survey responses as discussed in the context of 230 in FIG. 2 above, and a corresponding weight display may be displayed in survey metric indicator 332.

In some embodiments, Survey Metrics Display 330 may display a survey metric indicator 332 corresponding to a single survey question. For example, Overall Recommendation 332b may indicate the percentage of survey responses that indicated a recommendation of the automobile dealership. As shown in FIG. 3, Overall Recommendation 332b is Q14 as indicated by icon 326.

Date Range Display 340 may indicate a date range associated with the survey responses displayed in Survey Response Display 320. In some embodiments, the date range may correspond to a receipt date of a survey response. FIG. 3 shows a date range view associated with Details View 301. Date Range Display 340 displays dates ranging from Mar. 9, 2009-Mar. 16, 2009, indicating that the survey responses displayed in Survey Response Display 320 were received on or between those calendar dates. Any range of dates may be displayed in Date Range Display 340.

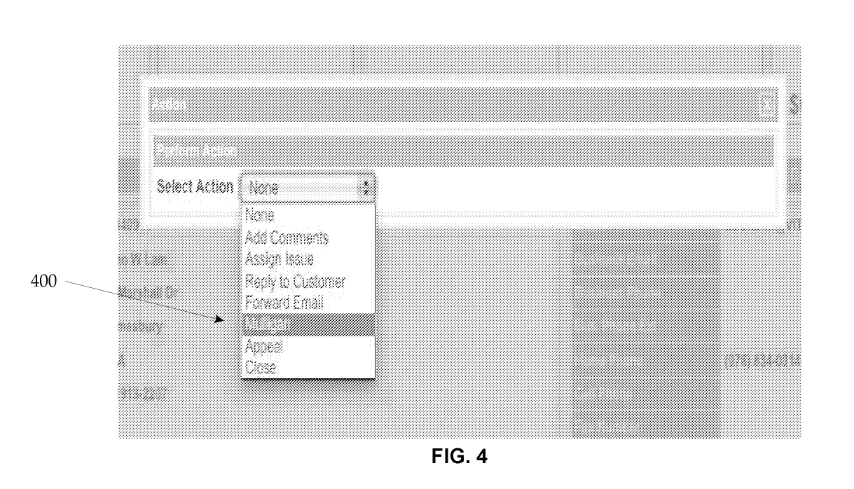

FIGS. 4-6 illustrate further features and/or views of the GUI 300 in accordance with embodiments of the present invention. These features and/or views are accessible via user input to any of 310-340 discussed in the context of FIG. 3.

FIG. 4 is a screenshot of an exemplary deduction or “mulligan” feature 400 as included in various embodiments of the graphical user interfaces discussed herein. According to one exemplary embodiment, after multiple survey responses having calculated values (e.g., a Customer Experience Index) are transmitted for display on a network device associated with a particular party (e.g., a computer belonging to an automobile dealer), the particular party may be allocated a certain number or percentage of total survey responses received during a pre-specified period of time that the party may elect to have deducted from their average calculated value for that pre-specified period. Such an allocation may be determined by another party, such as an automobile manufacturer and may be any number or any percentage of the survey responses. For example, if automobile dealer A received 300 survey responses for the month of January, yielding an average calculated value of 95 points out of a possible 100 points, automobile dealer A may be allowed by the automobile manufacturer to have two percent (2%) or six (6) of their lowest scores received for the month of January deducted from their average calculated value. Thus, if dealer A received six survey responses for the month of January, with each survey response having a calculated value of less than 95, dealer A may elect to have up to six (or all six) calculated values deducted from their calculated average value for the month of January, effectively increasing their average calculated value beyond 95.

According to a further exemplary embodiment, the allocation of survey responses a party may elect to have deducted from their average calculated value (e.g., 2% or six, with respect to the above example), may be transmitted for display on a network device associated with the particular party. According to yet a further exemplary embodiment, a deadline (e.g., calendar date) by which the allocation must be deducted by may be transmitted for display on the network device. For example, if automobile dealer A received 300 survey responses for the month of January, and is allowed to have up to 2% of their lowest scores received for the month of January deducted from their average calculated value, automobile dealer A may be given until ten days after the end of January (i.e., February 10^{th}) to elect to have up to six calculated values deducted from their average calculated value for the month of January.

Referring again to FIG. 4, according to some exemplary embodiments, each time a party uses the exemplary deduction or mulligan feature 400 in order to have a calculated value associated with a survey response deducted from their average calculated value, an updated average calculated value may be determined and transmitted for display on a network device. According to even further exemplary embodiments, deducted calculated values and/or associated survey responses are archived and retrievable by the network device. For example, if an automobile dealer desires to research the reason why they received a low calculated value for a particular survey response, they may be able to retrieve and view the particular survey response and associated score. Such responses may be searched by keyword.

According to one exemplary method of using the deduction or mulligan feature 400, a party (such as an automobile dealer) may utilize a graphical user interface (such as the exemplary graphical user interface) shown in FIG. 3 to click on a customer name 322. Another graphical user interface, such as the graphical user interface shown in FIG. 6A, may appear. Using an action prompt such as the exemplary action prompt 600, the party may elect to deduct or mulligan the survey response and associated score. Accordingly, the party may be directed to a graphical user interface, such as the graphical user interface shown in FIG. 4. Using the deduction or mulligan feature 400, the party may elect to have the survey response and associated score deducted from their average calculated value.

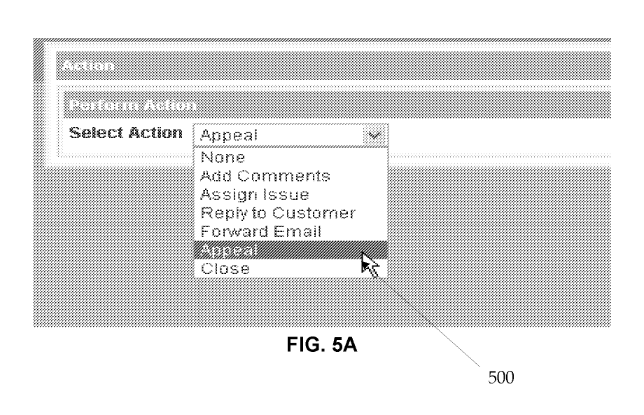

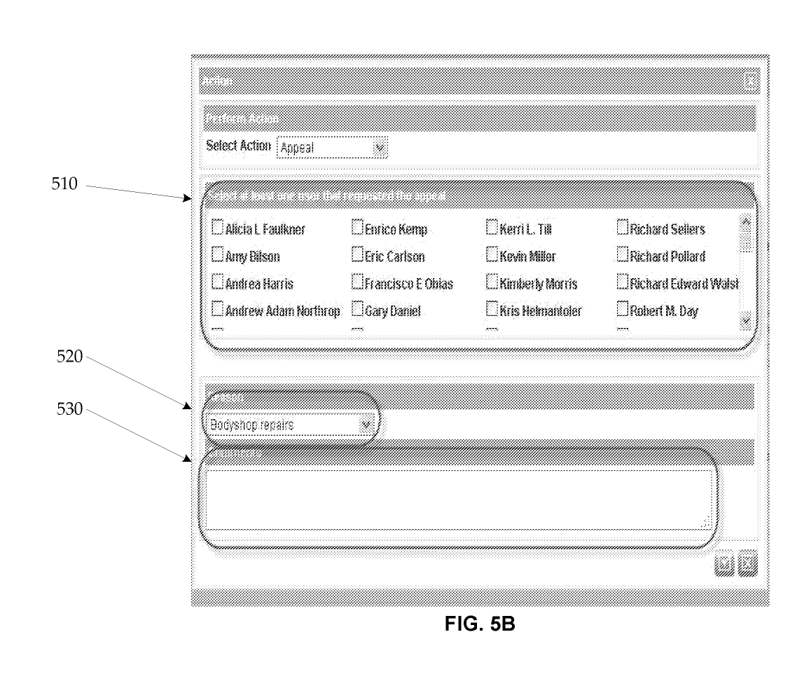

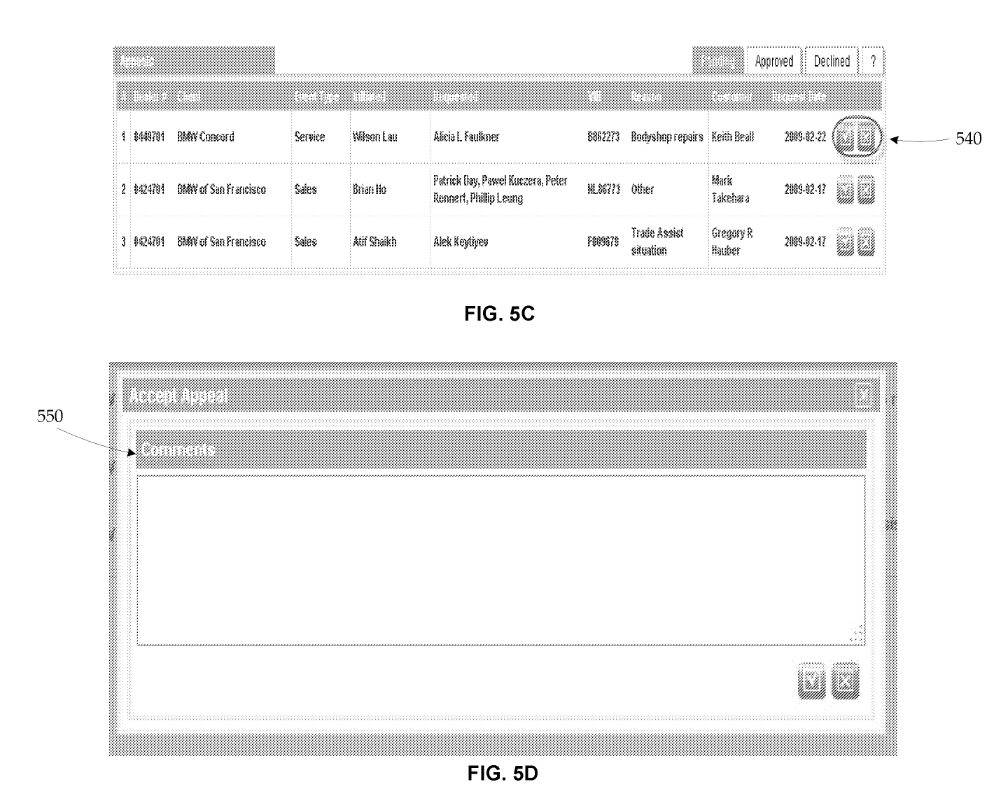

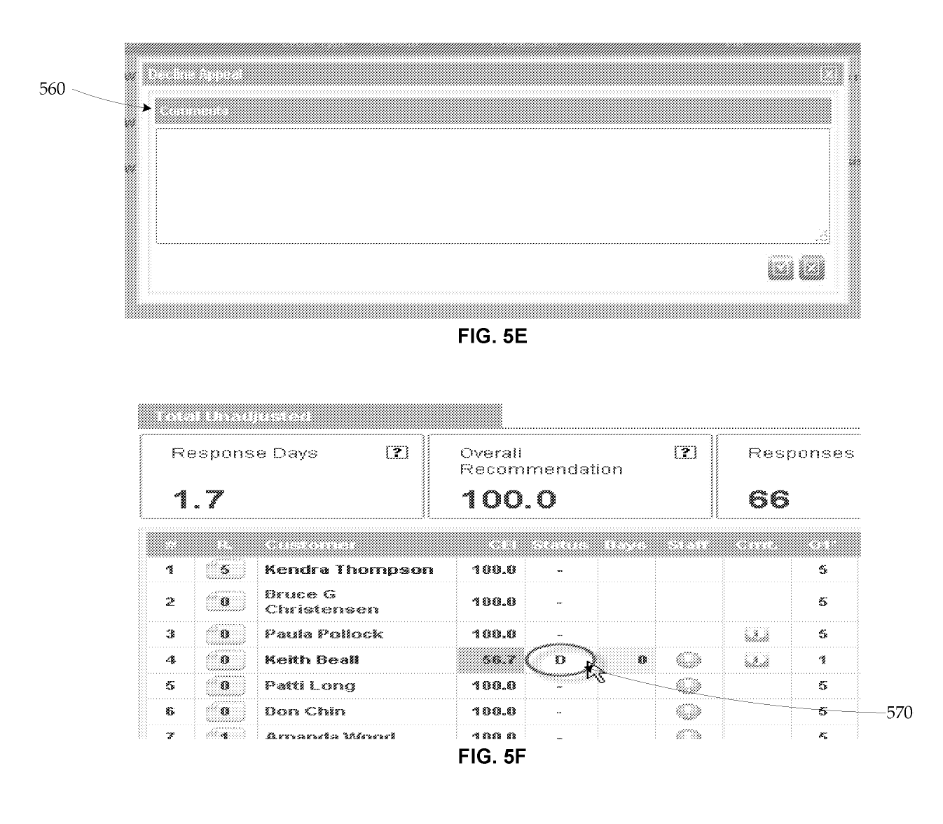

FIGS. 5A-5F show screenshots of an exemplary appeal feature 500 as included in various embodiments of the graphical user interfaces discussed herein. According to one exemplary embodiment, after a survey response having a score is transmitted for display on a network device associated with a particular party (e.g. a computer belonging to an automobile dealer), the particular party may wish to appeal inclusion of the score associated with the survey response in their average calculated value. Accordingly, the party may click or activate the appeal feature 500 of the exemplary graphical user interface as shown in FIG. 5A.

After clicking or activating the appeal feature 500, the party may be directed to the exemplary graphical user interface shown in FIG. 5B. Using the exemplary graphical user interface shown in FIG. 5B, the appealing party may enter their name at 510, reason for appeal at 520, and comments at 530. In some exemplary embodiments, the reason in support of the request to appeal may be such reasons as a body shop repair or a trade assist situation. According to a further exemplary embodiment, a notification of the appeal, such as in the form of an email, text, or voice mail, may be sent to a party responsible for deciding whether to accept or decline the appeal, such as an automobile manufacturer.

A party responsible for accepting or declining the appeal, such as the automobile manufacturer, may access an exemplary graphical user interface (such as the graphical user interface illustrated in FIG. 5C). Using a feature such as decision feature 540 as shown in FIG. 5C, the party may enter their decision, along with associated comments at box 550 in FIG. 5D (in the case of an accepted appeal) or at box 560 in FIG. 5E (in the case of a declined appeal). According to a further exemplary embodiment, a notification of the appeal decision, such as in the form of an email, text, or voice mail may be sent to the appealing party.

Referring to FIG. 5F, an exemplary graphical user interface is shown in which the appealing party may view whether an appeal has been declined, as shown by the “D” in status box 570. If the appeal is approved, the survey response is removed from being accessible by a network device of the appealing party and the associated score is deducted from their average calculated value.

FIGS. 6A-6D show screenshots of an exemplary issue resolution feature as included in various embodiments of the graphical user interfaces discussed herein.

According to various exemplary embodiments, if the score of a survey response is below a threshold, an issue report is transmitted for display on a network device (such as on the display of a networked computer of an automobile dealer). The threshold may be determined by another party, such as an automobile manufacturer. When the issue report is received by a party, such as an automobile dealership, a survey manager or other representative of the party may assign the issue report to another party for resolution.

Referring to FIG. 6A, using an action prompt such as the exemplary action prompt 600, the survey manager is directed a menu, such as the exemplary menu 610 shown in FIG. 6B. Using the exemplary menu 610, the survey manger may elect to assign the issue report to another party, such as an employee of the automobile dealership, for resolution. Accordingly, after the survey manager elects to assign the issue report using exemplary menu 610, the survey manager may be directed to a graphical user interface (such as the exemplary graphical user interface shown in FIG. 6C) to provide further detail regarding the issue report assignment.

Referring to FIG. 6C, the survey manager may use the exemplary assign issue feature 620 to assign a party to resolve the issue report. The survey manager may also add comments in the exemplary comment box 630. After entering the requested information in the exemplary graphical user interface shown in FIG. 6C, the issue report is transferred to the assigned party for resolution.

FIG. 6D shows an exemplary graphical user interface utilized by the assigned party to close an assigned issue report. Using the exemplary graphical user interface, the assigned party may use the exemplary close feature 640 to indicate the successful resolution of the issue report. The assigned party may enter comments in the exemplary comments box 650. The assigned party may also enter an approximate cost to successfully resolve the issue report in the exemplary approximate cost box 660. According to a further exemplary embodiment, a time period may be tracked starting with the transmitting of the issue report to the survey manager and ending with closure of the issue report by the assigned party. Additionally, notification may be transmitted from the network device to another party (such as an automobile manufacturer) that the issue has been resolved. A request for confirmation that the issue report has been satisfactorily resolved and therefore closed may be sent to the party that originally submitted the issue report (e.g., the customer).

The above-described functions and/or methods may include instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. Those skilled in the art are familiar with instructions, processor(s), and storage media. Exemplary storage media in accordance with embodiments of the invention are illustrated in FIG. 1, which may include, but is not limited to any of components 105-197.

Upon reading this paper, it will become apparent to one skilled in the art that various modifications may be made to the systems, methods, and media disclosed herein without departing from the scope of the disclosure. As such, this disclosure is not to be interpreted in a limiting sense but as a basis for support of the appended claims.

1. A system for management of a survey response associated with a score, the system comprising:
a processor;
a computer readable storage medium having instructions for execution by the processor which causes the processor to manage the survey response associated with the score;
wherein the processor is coupled to the computer readable storage medium, the processor executing the instructions on the computer readable storage medium to:
transmit the survey response associated with the score for display on a network device;
if the score of the survey response is below a threshold, transmit an issue report for display on the network device; and
transmit a calculated value for display on the network device, the calculated value based at least in part on the score associated with the survey response.

2. The system of claim 1, the system further comprising the processor executing the instructions on the computer readable storage medium to:
transmit for display on the network device a quantity representing a number of survey responses that may have their associated score deducted from the calculated value.

3. The system of claim 2, the system further comprising the processor executing the instructions on the computer readable storage medium to:
transmit for display on the network device a deadline for when one or more of the associated scores must be deducted from the calculated value.

4. The system of claim 2, wherein the quantity is based at least in part on a total number of survey responses received during a pre-specified time period.

5. The system of claim 2, wherein at least one of the associated scores is deducted from the calculated value.

6. The system of claim 5, the system further comprising the processor executing the instructions on the computer readable storage medium to:
transmit an updated calculated value for display on the network device.

7. The system of claim 5, the system further comprising the processor executing the instructions on the computer readable storage medium to:
store the deducted score and associated survey response for access by the network device.

8. The system of claim 1, the system further comprising the processor executing the instructions on the computer readable storage medium to:
receive from the network device a request to appeal inclusion of the score associated with the survey response in the calculated value.

9. The system of claim 8, the system further comprising the processor executing the instructions on the computer readable storage medium to:
receive from the network device a reason in support of the request to appeal inclusion of the score associated with the survey response in the calculated value.

10. The system of claim 9, wherein the reason in support of the request to appeal is a body shop repair or a trade assist situation.

11. The system of claim 8, the system further comprising the processor executing the instructions on the computer readable storage medium to:
transmit for display on the network device a granting of the request to appeal, the granting resulting in deduction of the associated score from the calculated value.

12. The system of claim 11, the system further comprising the processor executing the instructions on the computer readable storage medium to:
remove the survey response associated with the deducted score from access by the network device.

13. The system of claim 8, the system further comprising the processor executing the instructions on the computer readable storage medium to:
transmit for display on the network device a rejection of the request to appeal.

14. The system of claim 1, the system further comprising the processor executing the instructions on the computer readable storage medium to:
receive from the network device an assignment of the issue report to a party responsible for resolution of an issue associated with the issue report.

15. The system of claim 1, the system further comprising the processor executing the instructions on the computer readable storage medium to:
track a time period starting with the transmitting of the issue report and ending with closure of the issue report.

16. The system of claim 14, the system further comprising the processor executing the instructions on the computer readable storage medium to:
receive from the network device an indication that the issue has been resolved.

17. The system of claim 14, the system further comprising the processor executing the instructions on the computer readable storage medium to:
receive from the network device an indication that the issue report has been closed.

18. The system of claim 17, the system further comprising the processor executing the instructions on the computer readable storage medium to:
transmit a request for confirmation that the issue report has been satisfactorily closed.

19. The system of claim 18, the system further comprising the processor executing the instructions on the computer readable storage medium to:
receive a response to the request for confirmation that the issue report has been satisfactorily closed.

20. The system of claim 19, the system further comprising the processor executing the instructions on the computer readable storage medium to:
if the received response indicates that the issue report has not been satisfactorily closed, transmit a new issue report for display on the network device.

21. A graphical user interface for management of a survey response associated with a score, the graphical user interface comprising:
a survey response display, the survey response display configured to display a survey response associated with a score;
an issue report display, the issue report display configured to display an issue report if the score of the survey response is below a threshold; and
a calculated value display, the calculated value display configured to display a calculated value based at least in part on the score associated with the survey response.

22. The graphical user interface of claim 21, wherein the calculated value is a customer experience index.

23. The graphical user interface of claim 21, the graphical user interface further comprising a status display, the status display configured to display a status of the survey response.

24. The graphical user interface of claim 23, wherein the status is any of appealed, mulligan, open, closed or any combination thereof.

25. The graphical user interface of claim 21, the graphical user interface further comprising a comment display, the comment display configured to display a comment about the survey response.
